(19) United States
(12) Patent Application Publication
(10) Pub. No.: US 2005/0162171 A1
(43) Pub. Date: Jul. 28, 2005

(54) Spark plug wire high-voltage sensor apparatus

(75) Inventor: Michael L. Whitehead, Clarinda, IA (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA (US)

(21) Appl. No.: 10/762,720

(22) Filed: Jan. 22, 2004

(51) Int. Cl. F02P 17/00

(52) U.S. Cl. 324/393

(57) ABSTRACT

A device for sensing a high voltage pulse in a spark plug wire in the form of a mechanical pen provides a neon bulb within a translucent or transparent tube having conductive members at the opposite ends of the tube connected with the neon bulb. A probe member at one end is formed or shaped to fit over a plug wire to enhance capacitive coupling so that current will be induced into the device upon the passage of a high voltage pulse through a plug wire.

### BACKGROUND OF THE INVENTION

In a principal aspect, the present invention relates to a device which is used to determine the presence of a high voltage pulse in the wire to a spark plug of an internal combustion engine, such detection indicating that the spark plug and associated circuitry are functioning in a normal manner.

Auto mechanics often find it necessary to determine the electrical continuity of the circuits which provide an electric charge to the spark plugs of an internal combustion engine. Typically, a high voltage pulse is supplied through a distribution system of conductive electric wires separately to the engine spark plugs. Of course, the distribution or ignition system provides, in effect, a high voltage pulse to the plugs in a defined and sequential manner in order to cause the plugs to fire appropriately and ignite a fuel and air mixture. Should there be any discontinuity in such an electric pulse indicating a fouled spark plug, the engine will not operate in a proper manner. Thus, an auto mechanic, when diagnosing engine problems, will desire to determine whether each individual wire to each individual spark plug provides an appropriate timed high voltage pulse. Once it is determined that an appropriate high voltage pulse is provided to each plug, the electrical distribution for the spark plugs is verified as operating in a proper manner. The mechanic can then investigate other alternatives or reasons why an ignition system or engine is not functioning properly.

For checking the electric continuity and the presence of an appropriate high voltage pulse in the ignition wires of a vehicle, there is available a product made by Kastar Hand Tools of Racine, Wis. which incorporates the use of a probe that is placed in the vicinity of the boot associated with a spark plug. The device is in the form or shape of a pen. A neon bulb is incorporated in the device. The flow of current through the boot apparently will induce a current in the neon bulb and provide a visible indication that there is required current flow to the spark plug boot.

While such a device appears to be quite useful, there nonetheless remains the need to provide a device which can be utilized in association with a spark plug wire distribution system that can be placed at any position along the wire leading to a spark plug so as to investigate the continuity of the conductive path and whether there might be a break in that continuity at some point along the wire. This objective, among others, has led to the development of the present invention.

### SUMMARY OF THE INVENTION

Briefly, the present invention comprises an apparatus for determination of the presence of a high voltage pulse in a spark plug wire for an internal combustion engine. The apparatus or device has the size and shape of a fountain pen and includes a conductive handle, for example, a handle made from an aluminum rod. The handle is connected to a nonconductive, cylindrical, translucent tube which houses a neon bulb that is biased into engagement with one end of the conductive handle. The opposite end of the translucent tube receives a conductive probe member. The probe member includes a special formed concave end which is designed to fit over a spark plug wire. The probe member, biasing member or spring, neon bulb and handle together form a series circuit.

A mechanic or individual uses the tool by placing the shaped probe over a spark plug wire. Holding the handle will then connect the circuit to ground. A high voltage pulse occurring on the spark plug wire will, through capacitive coupling, cause current flow through the device which will, in turn, pass through the individual holding the apparatus to ground. The neon bulb within the translucent tube will register the passage of such current by flashing or providing a visual indication of a low current flow. The probe is shaped so that the capacitive coupling is enhanced inasmuch as the probe has a curved generally, concave conical shape that fits around the plug wire thereby enhancing the capacitive coupling and increasing current flow through the apparatus.

Thus, it is an object of the invention to provide an apparatus for determination of a high voltage pulse in a spark plug wire.

It is a further object of the invention to provide an inexpensive, yet highly reliable and effective apparatus which will enable an auto mechanic to determine if there is a shorted or fouled spark plug, which is indicated by absence of light on the neon bulb.

Another object of the invention is to provide an apparatus for determination of a high voltage pulse in a spark plug wire along the length of the wire.

A further object of the invention is to provide an apparatus for determination of a high voltage pulse in a spark plug wire wherein the apparatus is easy to use, easy to manipulate, inexpensive and highly reliable.

These and other objects, advantages and features of the invention will be set forth in the detailed description which follows.

### BRIEF DESCRIPTION OF THE DRAWING

In the detailed description which follows, reference will be made to the drawings comprised of the following figures:

FIG. 1 is a plan view of the apparatus of the invention;

FIG. 2 is an exploded isometric view of the apparatus of FIG. 1;

FIG. 3 is an isometric view illustrating the manner of use of the apparatus of FIGS. 1 and 2;

FIG. 4 is a plan view of the probe member incorporated in the apparatus of the invention;

FIG. 5 is an end view of the probe of FIG. 4;

FIG. 6 is a cross sectional view of the probe member of FIG. 4 taken along the line 6-6; and

FIG. 7 is a circuit diagram illustrating the function and use of the tool or apparatus.

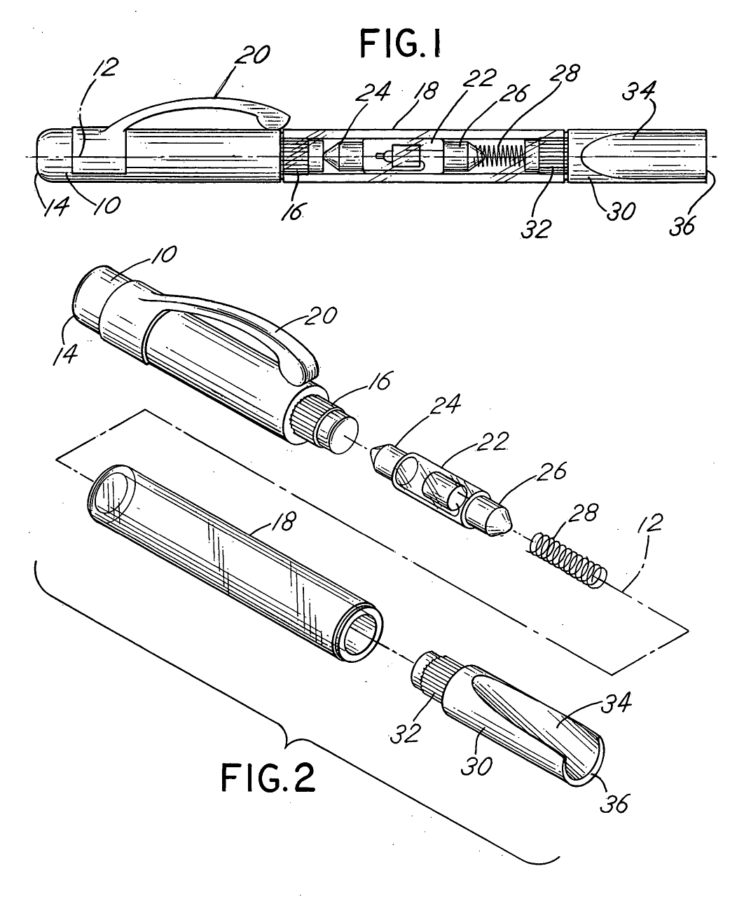

### DESCRIPTION OF THE PREFERRED EMBODIMENT

The apparatus of the invention has the general form, shape and size of a typical fountain pen, mechanical pen or pencil. This enables a mechanic to easily carry and easily use the apparatus because of its convenient size and shape.

Referring to the figures, the device includes a handle 10. The handle 10 is in the form of a cylinder having a longitudinal axis 12. The handle 10 includes an outer end 14 and an inner end 16 having a reduced diameter which is knurled. The knurled end 16 is designed to receive a translucent or transparent hollow tube 18. The hollow tube 18 has a diameter which enables it to be pressed onto the knurled or gripping end 16 of the handle 10 which insures that the hollow tube 18 remains fixed on the knurled end 16 of the handle 10. The handle 10 further includes a pocket retention clip 20 fitted thereon. The pocket clip 20 enables the user of the device to retain the device in a pocket much in the manner of a mechanical pencil or pen.

The transparent or translucent tube 18 is nonconductive whereas the handle 10 is made from a conductive material. Positioned within the hollow tube 18 is a neon bulb 22 having a first contact end 24 in electrical contact with the knurled end 16 of the handle 10. The bulb 22 further includes a second contact end 26 which engages with a biasing member; namely, a conductive spiral spring 28.

A probe member 30 includes a shaped or knurled end 32 which presses into the opposite end of the hollow tube 18 and conductively engages with the spring 28. The probe member 30 is made from an aluminum or other conductive material as is the handle 10. The handle 10, the hollow tube 18 and the probe member 30 are all coaxial with axis 12 and have a generally uniform diameter so that the entire assembly has a generally uniform diameter.

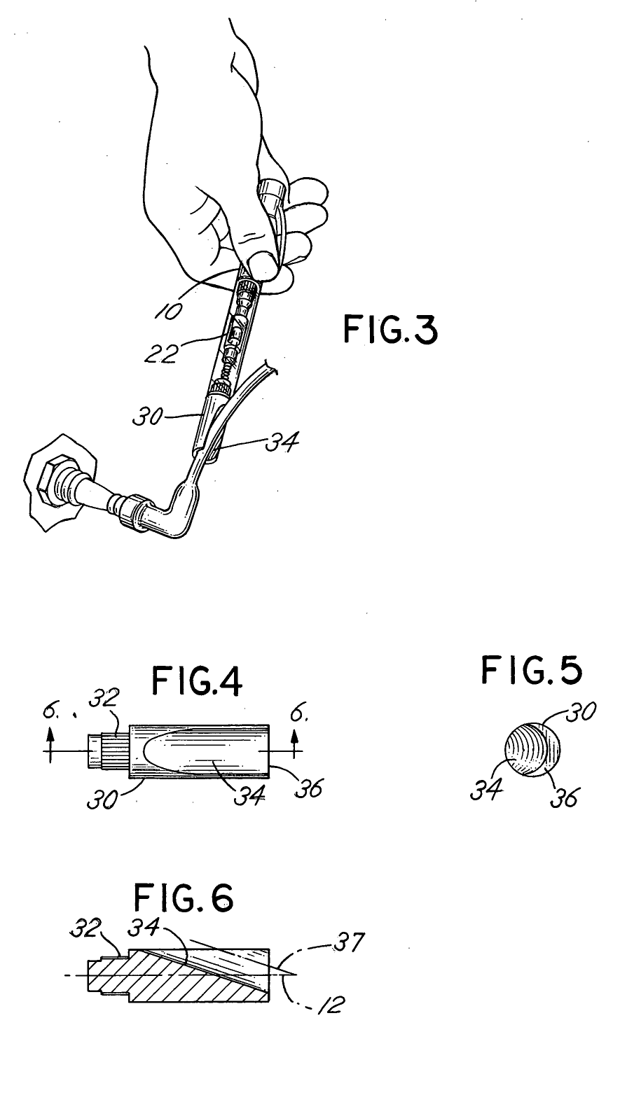

The probe member 30 further includes a concave, frustoconical or conical surface 34. This enables the probe member 30, and more particularly, the surface 34 to be placed closely adjacent and over a distribution or spark plug wire as illustrated in FIG. 3. The concave shape of surface 34 maximizes an inductive surface area for placement over a generally cylindrical wire. Consequently, the device is highly sensitive. The probe member 30 further includes a planar or flat distal end 36. The length of the probe member 30 is in the range of one half to one inch. The concave surface 34 extends axially from the distal end 36 toward the handle 10 and the major diameter of the concave surface 34 is at the distal end 36. As depicted in FIGS. 4-6, the surface 34 is a regular cylindrical surface cut into the probe member having an angle between the longitudinal axis 37 and axis 12 in the range of 15-25°.

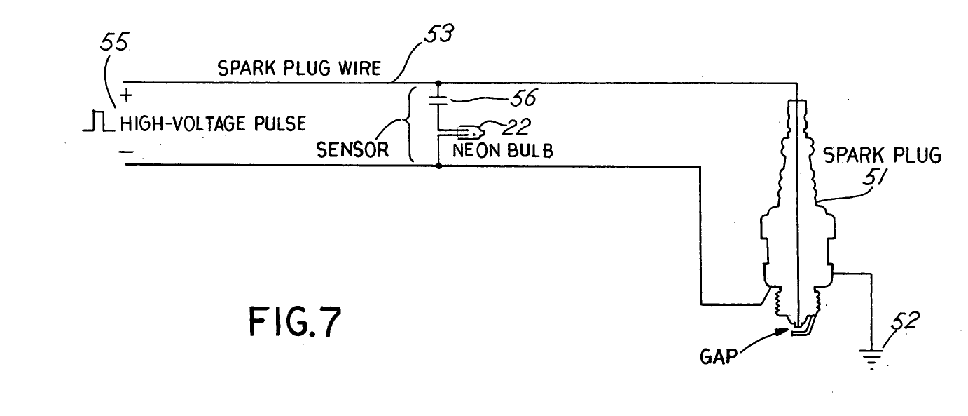

In use, the curved section, or surface 34 is placed over a plug wire 53 connected to plug 51 as diagrammatically illustrated in FIG. 7. This, in essence, forms an electrical capacitor. A high voltage source 55 to plug 51 induces a very small current flow through the device to the neon bulb 22 and to ground 52 through the person that is holding the clip end or handle 10. The physical arrangement and configuration is illustrated in FIG. 3. If the plug is not fouled, then the light will go on. If the plug is fouled, then the current will be high and no capacitive coupling will occur. The light will not go on indicating a defect.

While there has been set forth a preferred embodiment of the invention it is to be understood that the invention is limited only by the following claims and equivalents thereof.

1. An apparatus for sensing a high voltage pulse in a spark plug wire of an internal combustion engine comprising, in combination;
a handle of conductive material having an outer end and an inner contact end, said handle defining a longitudinal axis;
a translucent bulb retention tube of nonconductive material affixed to the inner contact end of the handle, said tube comprising an axial extension from the handle; and having an opposite tube end;
a bulb positioned in the tube said bulb including a first contact in electrical communication with the inner contact end of the handle and a second contact end extending in the opposite axial direction in the tube; and
a conductive probe member attached to the opposite tube end, said conductive probe member electrically connected to the second contact end of said bulb to form a series circuit through the probe, the bulb and the handle, said probe further including a probe end spaced from the connection to the tube, said probe end configured to fit over a spark plug wire whereby manual placement of the probe over a wire having a high voltage pulse will by capacitive coupling to the probe generate a current flow through the bulb to ground.

2. The apparatus of claim 1 wherein the probe end of the probe member comprises a partial concave surface.

3. The apparatus of claim 1 further including a conductive biasing member in the tube forming a part of the series circuit between the handle and the probe member.

4. The apparatus of claim 1 wherein the handle, tube and probe member are coaxial and generally cylindrical with a uniform diameter.

5. The apparatus of claim 1 further including a pocket retention clip on the handle.
